(19) United States
(12) Patent Application Publication
(10) Pub. No.: US 2026/0294050 A1
(43) Pub. Date: Oct. 1, 2026

(54) SEPARABLE FASTENING DEVICES, SYSTEMS, AND METHODS

(71) Applicant: Patmos Enterprises, LLC, Richardson, TX (US)

(72) Inventor: Jeffrey A. Ozanne, Richardson, TX (US)

(73) Assignee: Patmos Enterprises, LLC, Richardson, TX (US)

(21) Appl. No.: 19/633,366

(22) Filed: Mar. 30, 2026

Related U.S. Application Data
(60) Provisional application No. 63/780,885, filed on Mar. 31, 2025.

(51) Int. Cl. A44B 18/00; H01F 7/02

(52) U.S. Cl. CPC A44B 18/008; A44B 18/0007; H01F 7/0263

(57) ABSTRACT

A fastening device. The fastening device includes a base having a first coupling surface. A plurality of elongate members extends from the first coupling surface of the base. The plurality of elongate members includes a magnetic powder particulate distributed within an elastomeric material.

### TECHNICAL FIELD

The subject matter disclosed herein relates to the field of fasteners for garments, pouches, baggage, covers, sheets, etc., and in particular, to separable fasteners to engage each other to secure components together.

### BACKGROUND

Separable fastening devices may be used to secure components together, including for example, garments, clothing, pouches, baggage, covers, sheets, etc. Separable fastening devices, such as zippers, buttons, hook-and-loop (e.g., Velcro ®), etc., generally make noise during fastening/unfastening and are difficult to align. Many separable fastening devices have a short life span due to debris interfering with the fastening mechanism and creating wear on the device.

### SUMMARY

According to one aspect, a fastening device. The fastening device includes a base having a first coupling surface. A plurality of elongate members extends from the first coupling surface of the base. The plurality of elongate members includes a magnetic powder particulate distributed within an elastomeric material.

According to another aspect, a fastening device. A first base includes a first coupling surface. A plurality of first elongate members extends from the first coupling surface of the first base. The plurality of first elongate members includes a first magnetic powder particulate. A second base includes a second coupling surface. A plurality of second elongate members extends from the second coupling surface of the second base. The plurality of second elongate members includes a second magnetic powder particulate.

According to another aspect, a method of releasably fastening components. A first magnetic strap is aligned with a second magnetic strap. The first magnetic strap includes a plurality of first elongate members having a first magnetic powder particulate. The second magnetic strap includes a plurality of second elongate members having a second magnetic powder particulate. A force is applied to the first magnetic strap to urge movement toward the second magnetic strap. The plurality of first elongate members are configured to mechanically and magnetically engage the plurality of second elongate members.

### BRIEF DESCRIPTION OF THE DRAWINGS

FIG. 1A is a diagrammatic side view of a separable fastening device, according to some embodiments.

FIG. 1B is a diagrammatic side view of the separable fastening device with the first magnetic strap and the second magnetic strap coupled, according to some embodiments.

FIG. 1C is a magnified diagrammatic view of a first elongate member engaged with a second elongate member, according to some embodiments.

FIG. 1D is a diagrammatic side view of the first magnetic strap, according to some embodiments.

FIG. 1E is a diagrammatic top view of the first magnetic strap, according to some embodiments.

FIG. 2 is a diagrammatic side view of a separable fastening device, according to some embodiments.

FIG. 3 is a diagrammatic side view of a separable fastening device, according to some embodiments.

FIG. 4 is a diagrammatic side view of a separable fastening device, according to some embodiments.

FIG. 5A is a diagrammatic side view of a separable fastening device with fibrous members, according to some embodiments.

FIG. 5B is a diagrammatic side view of a separable fastening device with fibrous members, according to some embodiments.

FIG. 5C is a diagrammatic side view of a separable fastening device with fibrous members, according to some embodiments.

FIG. 5D is a diagrammatic side view of a separable fastening device with fibrous members, according to some embodiments.

FIG. 6 is a flow chart of a method of releasably fastening components, according to some embodiments.

### DETAILED DESCRIPTION

The present disclosure describes devices, systems, and/or methods of separably fastening components (e.g., garments, clothing, pouches, baggage, covers, etc.) together with a magnetic strap. The magnetic strap includes a base portion which may be substantially flat, and a plurality of elongate members extending from the base portion. The base portion and/or the plurality of elongate members may include magnetic elements, including for instance, a ferromagnetic powder, loaded in an elastomeric material (e.g., a flexible elastomer or a thermoplastic). The magnetic strap is configured to magnetically couple with a corresponding magnetic strap to separably fasten components together. The plurality of elongate members of a first magnetic strap may engage the plurality of elongate members of a second magnetic strap to provide magnetic shear forces to hold the two components together. The engagement between the plurality of elongate members may provide a cushion between the respective base portions to provide a silent coupling and decoupling with a smooth (i.e., shock absorbing) closure. The silent coupling and decoupling is beneficial, as the magnetic strap may be used on hunting, military, law enforcement, or other applications where noise is detrimental. The magnetic strap may provide automatic alignment to aid a user in quickly and properly securing components together. The elastomeric elongate members may be resistant to debris and water and can be easily cleaned to provide a long lifespan.

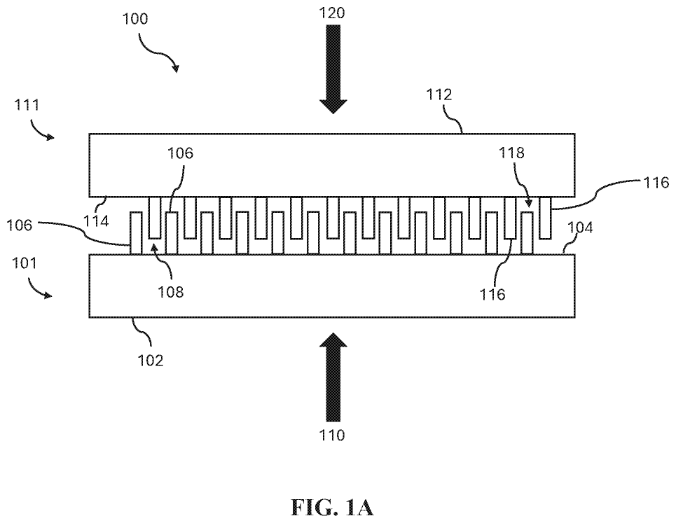

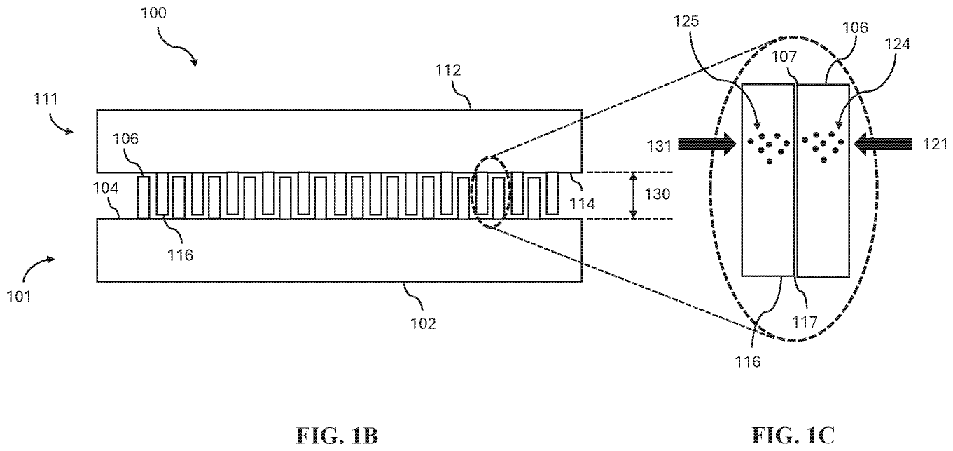

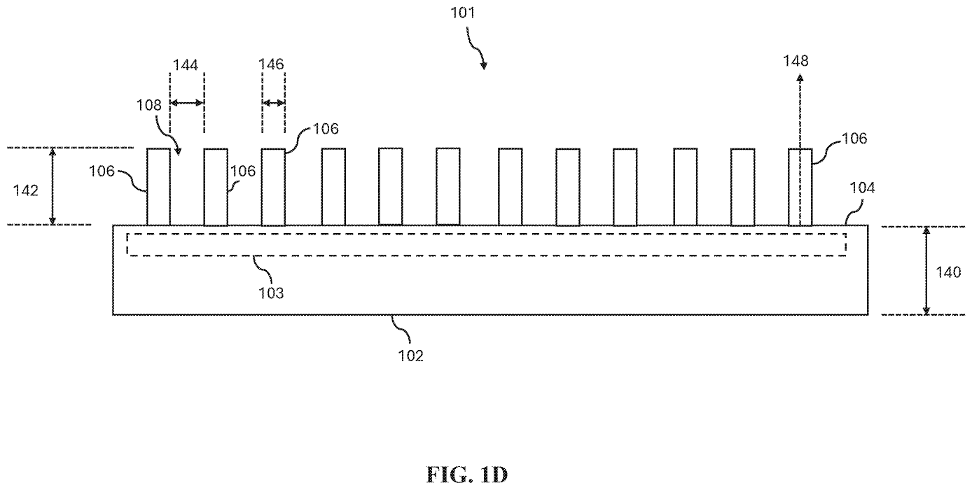

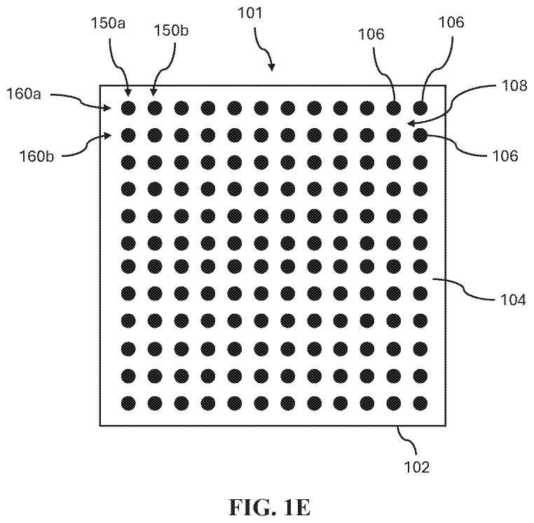

FIG. 1A is a diagrammatic side view of a separable fastening device 100, according to some embodiments. The separable fastening device 100 includes a first magnetic strap 101 and a second magnetic strap 111. The first magnetic strap 101 includes a first base 102 having a first coupling surface 104. The first magnetic strap 101 includes a plurality of first elongate members 106 extending from the first coupling surface 104 of the first base 102. A first gap 108 (or a plurality of gaps) is positioned between adjacent elongate members 106. The second magnetic strap 111 includes a second base 112 having a second coupling surface 114. The second magnetic strap 111 includes a plurality of second elongate members 116 extending from the second coupling surface 114 of the second base 112. A second gap 118 (or a plurality of gaps) is positioned between adjacent elongate members 116.

The first magnetic strap 101 may include a first magnetic polarity opposite to a second magnetic polarity of the second magnetic strap 111, and thus, the first magnetic strap 101 and the second magnetic strap 111 may be magnetically attracted to each other. Arrows 110, 120 indicate magnetic attraction of the first magnetic strap 101 and the second magnetic strap 111, i.e., the first magnetic strap 101 and the second magnetic strap 111 are urged to move toward each other via the magnetic attraction.

The first base 102 and/or the second base 112 may include one or more magnetic elements, including for instance, flexible magnetic strips. The flexible magnetic strips may include neodymium and/or neodymium iron boron. The flexible magnetic strips may be thermoset and/or coated with a thermoplastic to provide an elastomeric surface or magnetic elements laid into fabrics. The first base 102 and the second base 112 may have opposite magnetic polarity to magnetically attract each other.

The plurality of first elongate members 106 may include one or more magnetic elements. The plurality of first elongate members 106 may include a magnetic powder particulate including a ferrous material such as iron, iron alloy, iron boron, or steel. Other exemplary materials that the magnetic powder particulate may include are ferritic stainless steel, magnetic stainless steel, neodymium, neodymium iron boron, SAE Steel Grade 400 Series stainless steel, and 18-0 Series stainless steel and its magnetic equivalents. The magnetic powder particulate may include a corrosion resistant iron alloy with particles having an average size of 0.02 inches or less. Corrosion resistant particles may be desirable because the first magnetic strap 101 may be used in outdoor environments. The magnetic powder particulate may be distributed throughout the plurality of first elongate members 106 via an elastomeric material (e.g., a flexible elastomer or a thermoplastic material). The magnetic powder particulate may coat each of the plurality of elongate members 106, for instance, via spraying, dipping, or coating the plurality of elongate members 106 with the magnetic powder particulate filled elastomer. Percent by weight of magnetic powder particulate within the plurality of first elongate members 106 may be within a range of 20% and 95%. In some embodiments, the magnetic powder particulate accounts for at least 30% of the plurality of first elongate members 106 by weight. The plurality of first elongate members 106 may include an elastomeric thermoplastic material. The elastomeric thermoplastic material may provide an elastomeric surface or coating to reduce noise and absorb mechanical vibrations from coupling/decoupling the first magnetic strap 101 with the second magnetic strap 111.

The plurality of first elongate members 106 may be received within the second gaps 118 of the second magnetic strap 111. The plurality of first elongate members 106 may have opposite magnetic polarity to the second base 112, such that the plurality of first elongate members 106 is magnetically attracted to the second base 112. In some embodiments, the plurality of first elongate members 106 may contact the second coupling surface 114 of the second base 112.

The plurality of second elongate members 116 may include one or more magnetic elements. The one or more magnetic elements of the plurality of second elongate members 116 may include any and/or all features of the one or more magnetic elements of the plurality of first elongate members 106 described above. For instance, the plurality of second elongate members 116 may include a magnetic powder particulate including a ferrous material such as iron, iron alloy, iron boron, steel, a ferritic stainless steel, a magnetic stainless steel, neodymium, neodymium iron boron, and/or SAE Steel Grade 400 Series stainless steel. The one or more magnetic elements of the plurality of second elongate members 116 may have an opposite polarity to the one or more magnetic elements of the plurality of first elongate members 106.

The plurality of second elongate members 116 may be received within the first gaps 108 of the first magnetic strap 101. The plurality of second elongate members 116 may have opposite magnetic polarity to the first base 102, such that the plurality of second elongate members 116 is magnetically attracted to the first base 102. In some embodiments, the plurality of second elongate members 116 may contact the first coupling surface 104 of the first base 102.

FIG. 1B is a diagrammatic side view of the separable fastening device 100 with the first magnetic strap 101 and the second magnetic strap 111 coupled, according to some embodiments. The first coupling surface 104 of the first base 102 and the second coupling surface 114 of the second base 112 may be separated by a separation distance 130. The separation distance 130 may be determined via one or more of the strength of the magnetic attraction between the first magnetic strap 101 and the second magnetic strap 111, the lengths of the plurality of first elongate members 106 and/or the plurality of second elongate members 116, and the compliance (or stiffness) of the plurality of first elongate members 106 and/or the plurality of second elongate members 116. The plurality of second elongate members 116 may contact the first coupling surface 104 of the first base 102 and/or the plurality of first elongate members 106 may contact the second coupling surface 114 of the second base 112.

FIG. 1C is a magnified diagrammatic view of a first elongate member 106 engaged with a second elongate member 116, according to some embodiments. The first elongate member 106 includes a first engagement surface 107 and first magnetic powder particulates 124, and the second elongate member 116 includes a second engagement surface 117 and second magnetic powder particulates 125. As stated above, the one or more magnetic elements of the plurality of second elongate members 116 (e.g., second magnetic powder particulates 125) may have an opposite polarity to the one or more magnetic elements of the plurality of first elongate members 106 (e.g., first magnetic powder particulates 124). The first elongate member 106 may be magnetically attracted to the second elongate member 116, as indicated by the arrows 121, 131. The first engagement surface 107 may engage the second engagement surface 117 to provide a retention force to secure the first magnetic strap 101 to the second magnetic strap 111. The engagement between the first elongate member 106 and the second elongate member 116 may provide resistance to shear force which opposes decoupling of the first magnetic strap 101 and the second magnetic strap 111. For instance, the magnetic attraction of the first elongate member 106 to the second elongate member 116 may generate normal forces upon the first engagement surface 107 and the second engagement surface 117 which increase static and dynamic friction between the first engagement surface 107 and the second engagement surface 117, thereby opposing shear forces.

FIG. 1D is a diagrammatic side view of the first magnetic strap 101, according to some embodiments. The first base 102 includes a base magnet 103 and a base thickness 140, the first elongate member 106 includes an elongate member height 142 and a width 146, the first gap 108 includes a gap width 144, and the first elongate member 106 includes a longitudinal axis 148. The base thickness 140 may be greater than the elongate member height 142 of the first elongate member 106.

The elongate member height 142 is greater than the width 146. An aspect ratio of the elongate member height 142 relative to the width 146 is greater than 2:1. As used herein, an aspect ratio of an elongate member may refer to a ratio of a characteristic length or height of the elongate member to a characteristic width or diameter of the elongate member. In some embodiments, the aspect ratio may be within a range of 100:1 and 3:1, in some embodiments the aspect ratio may be within a range of 25:1 and 5:1, and in some embodiments the aspect ratio may be greater than 10:1. In some embodiments, the aspect ratio of the elongate member height 142 relative to the width 146 (or diameter of the first elongate member 106) may be greater than 100:1, and in such cases, the first elongate member 106 may be referred to as a fiber (a minimum acceptable ratio for a material to be considered a fiber is usually around 100:1). A higher aspect ratio of the first elongate member 106 may provide increased surface area engagement with a corresponding (opposite polarity) second elongate member (e.g., the second elongate member 116). Increased surface area engagement increases friction between the first magnetic strap 101 and the second magnetic strap 111, providing a stronger connection. However, a high aspect ratio may decrease structural strength of the first elongate member 106 and/or may be limited by particle size of the magnetic powder particulate (i.e., the diameter of the first elongate member 106 will be greater than the diameter of particle size of the magnetic powder particulate). The aspect ratio for the first elongate member 106 may be selected based on the desired connection strength, durability, and particle size of the magnetic powder particulate. In some embodiments, the plurality of second elongate members 116 may have any or all dimensional features of the plurality of first elongate members 106 described herein.

The gap width 144 of the plurality of first elongate members 106 may be greater than the width 146 of the first elongate member 106. The elongate member height 142 may be greater than the gap width 144 of the plurality of first elongate members 106, which may be greater than the width 146 of the first elongate member 106. The first elongate member 106 may extend from the first coupling surface 104 of the first base 102 along a longitudinal axis 148. The longitudinal axis 148 may be substantially orthogonal to the first coupling surface 104. In some embodiments, the first elongate member 106 may extend parallel to the longitudinal axis 148 from base to tip (i.e., along the entire length of the first elongate member 106). In some embodiments where the aspect ratio is greater than 50:1 (i.e., the first elongate member 106 is fibrous), the first elongate member 106 may deviate from the longitudinal axis 148.

FIG. 1E is a diagrammatic top view of the first magnetic strap 101, according to some embodiments. The first magnetic strap 101 includes the plurality of first elongate members 106 arranged in an array including a first column 150a, a second column 150b, a first row 160a, and a second row 160b. The exemplary embodiment shown in FIG. 1E includes twelve rows and twelve columns, but other arrangements may be used. The plurality of first gaps 108 may be disposed between each adjacent column and each adjacent row, as well as between adjacent first elongate members 106. Each of the plurality of first elongate members 106 may include a cylindrical body. The exemplary embodiment shown in FIG. 1E shows each of the plurality of first elongate members 106 extending from the first base 102 orthogonal with the first coupling surface 104 (i.e., along the longitudinal axis 148 shown in FIG. 1D), however, other orientations and/or flexing of the plurality of first elongate members 106 may occur.

The engagement between the plurality of first elongate members 106 and the plurality of second elongate members 116 is beneficial for reducing mechanical vibrations and thereby reducing noise. For instance, the elastomeric material of the plurality of first elongate members 106 and the plurality of second elongate members 116 may include elastomeric qualities to absorb vibrations, and the engagement between the first and second elongate members 106, 116 provides a separation distance 130 to prevent the first base 102 and the second base 112 from contacting each other (which may generate a clap or snap sound).

The magnetic elements (namely, the magnetic powder particulate) distributed throughout the plurality of first elongate members 106 and the plurality of second elongate members 116 are beneficial, as the first elongate member 106 may be magnetically attracted to the second elongate member 116 to provide a retention force to secure the first magnetic strap 101 to the second magnetic strap 111. The engagement between the first elongate member 106 and the second elongate member 116 may provide resistance to shear force which opposes decoupling of the first magnetic strap 101 and the second magnetic strap 111. Further, the plurality of first elongate members 106 may have magnetic attraction to the second base 112 and/or the plurality of second elongate members 116 may have magnetic attraction to the first base 102 to provide increased magnetic retention between the first magnetic strap 101 and the second magnetic strap 111. The magnetic elements may also provide self-alignment for the separable fastening device 100, as for instance, the first magnetic strap 101 and the second magnetic strap 111 will attract and move towards each other when in close proximity.

The decoupling of the first magnetic strap 101 and the second magnetic strap 111 may produce minimal vibrations and noise. For instance, the release of magnets from each other produces little sound (as compared to a button snapping open, Velcro ® tearing loose, a zipper releasing, etc.). The decoupling may be smooth, as the elastomeric elongate members 106, 116 slide relative to each other, with the friction forces generated by magnets (as opposed to rough surfaces of other fasteners).

In some embodiments, the first magnetic strap 101 and the second magnetic strap 111 may have identical or substantially identical structures. The identical (or substantially identical) structure may reduce manufacturing costs, as a single component can be made (i.e., requiring a single set of molds, parts, etc.), as compared to two unique parts that require multiple different sets of molds and parts.

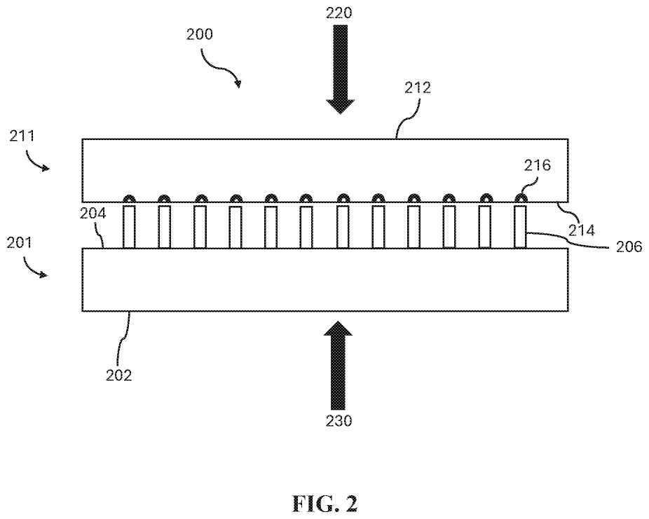

FIG. 2 is a diagrammatic side view of a separable fastening device 200, according to some embodiments. The separable fastening device 200 includes a first magnetic strap 201 and a second magnetic strap 211. The first magnetic strap 201 includes a first base 202 having a first coupling surface 204. The first magnetic strap 201 includes a plurality of first elongate members 206 extending from the first coupling surface 204 of the first base 202. The second magnetic strap 211 includes a second base 212 having a second coupling surface 214. The second magnetic strap 211 includes a plurality of cavities 216 extending into the second coupling surface 214, each of the plurality of cavities 216 configured to receive a first elongate member 206. The plurality of cavities 216 may include one or more of recesses, grooves, channels, sockets, slots, tapered cavities, and other receiving structures sized to at least partially receive corresponding first elongate members 206.

The first magnetic strap 201 may include any and/or all features of the first magnetic strap 101 described above with reference to FIGS. 1A-E. For instance, the first base 202 may include one or more magnetic elements, including for instance, flexible magnetic strips (e.g., neodymium and/or iron boron) and the plurality of first elongate members 206 may include one or more magnetic elements such as a magnetic powder particulate including a ferrous material such as iron, iron alloy, iron boron, and/or steel.

The second magnetic strap 211 may include one or more magnetic elements of opposite polarity to the first magnetic strap 201, including for instance, flexible magnetic strips (e.g., neodymium and/or iron boron) and/or a magnetic powder particulate including a ferrous material such as iron, iron alloy, iron boron, and/or steel. The first magnetic strap 201 and the second magnetic strap 211 may be magnetically attracted to each other, as indicated by arrows 220, 230. The plurality of cavities 216 may be configured to at least partially receive the plurality of first elongate members 206. Receiving the plurality of first elongate members 206 within the plurality of cavities 216 may increase surface area contact between the second magnetic strap 211 and the first magnetic strap 201 to provide increased static and dynamic friction to oppose shear forces, i.e., to retain the magnetic coupling between the first magnetic strap 201 and the second magnetic strap 211. The interaction between the plurality of first elongate members 206 and the plurality of cavities 216 and/or the second coupling surface 214 may provide a separation distance between the first coupling surface 204 and the second coupling surface 214 to reduce vibrations generated upon coupling and/or decoupling.

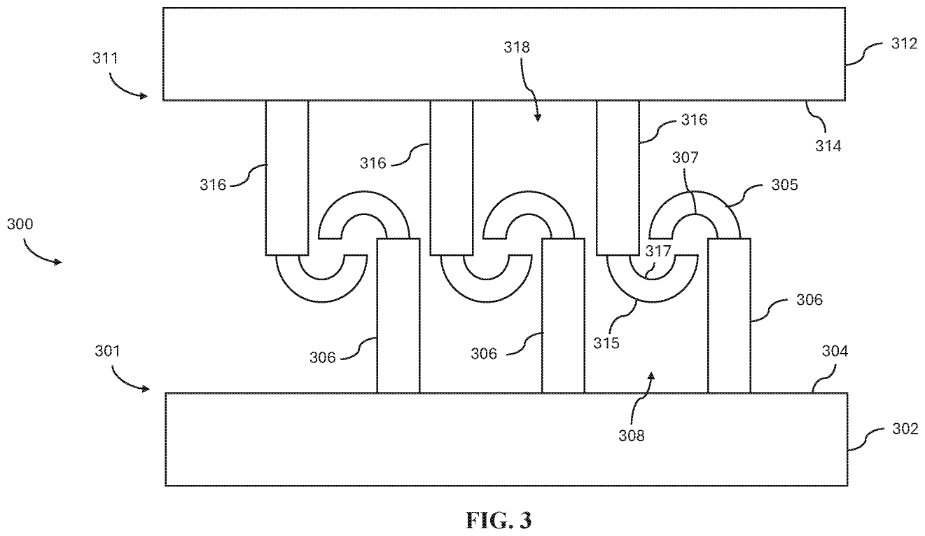

FIG. 3 is a diagrammatic side view of a separable fastening device 300, according to some embodiments. The separable fastening device 300 includes a first magnetic strap 301 and a second magnetic strap 311. The first magnetic strap 301 includes a first base 302 having a first coupling surface 304. The first magnetic strap 301 includes a plurality of first elongate members 306 extending from the first coupling surface 304 of the first base 302. The plurality of first elongate members 306 includes a first distal hook 305 having a concave surface 307. Adjacent first elongate members 306 are separated via a first gap 308. The second magnetic strap 311 includes a plurality of second elongate members 316 extending from the second coupling surface 314 of the second base 312. The plurality of second elongate members 316 includes a second distal hook 315 having a second concave surface 317. Adjacent second elongate members 316 are separated via a second gap 318.

The plurality of first elongate members 306 and the plurality of second elongate members 316 may include any and/or all features of the plurality of first elongate members 106 described above with respect to FIGS. 1A-E. For instance, the plurality of first elongate members 306 and the plurality of second elongate members 316 may include a magnetic powder particulate including a ferrous material such as iron, iron alloy, iron boron, steel, a ferritic stainless steel, a magnetic stainless steel, and SAE Steel Grade 400 Series stainless steel distributed throughout the plurality of elongate members via an elastomeric material. The first base 302 and the second base 312 may include a magnet element such as flexible magnetic strips (e.g., neodymium and/or iron boron) and/or a magnetic powder particulate. The first magnetic strap 301 and the second magnetic strap 311 may be magnetically attracted to each other.

The first distal hook 305 may engage the second distal hook 315 to retain the first magnetic strap 301 relative to the second magnetic strap 311. The engagement between the first distal hook 305 and the second distal hook 315 may provide mechanical retention, in addition to the magnetic retention between the first magnetic strap 301 and the second magnetic strap 311. The concave surface 307 of the first distal hook 305 may engage with the second concave surface 317 of the second distal hook 315. The concave surface 307 may be oriented to face the first coupling surface 304 and the second concave surface 317 may be oriented to face the second coupling surface 314. The magnetic powder particulate(s) in the plurality of first elongate members 306 and the plurality of second elongate members 316 may provide self-alignment of the concave surface 307 relative to the second concave surface 317. For instance, magnetic powder particulate(s) within the first distal hook 305 and the second distal hook 315 may be attracted to each other to engage the concave surface 307 with the second concave surface 317.

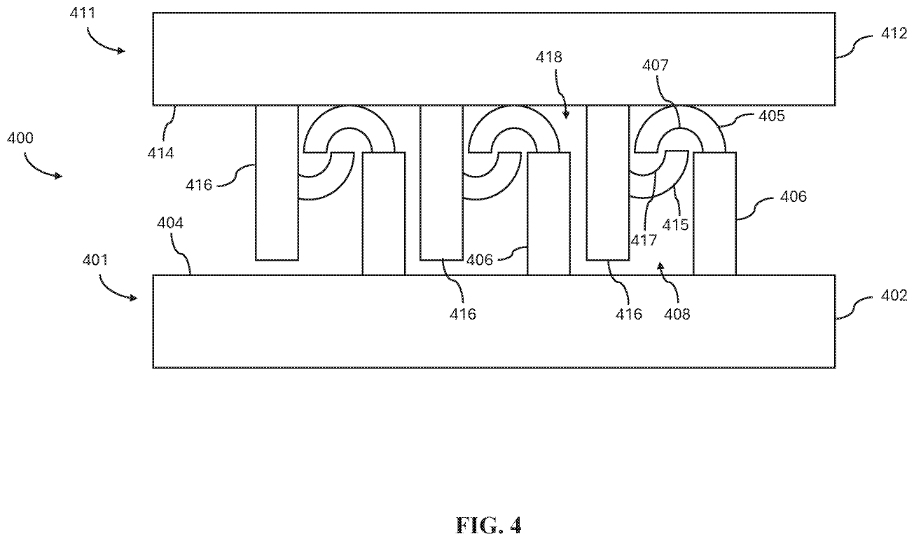

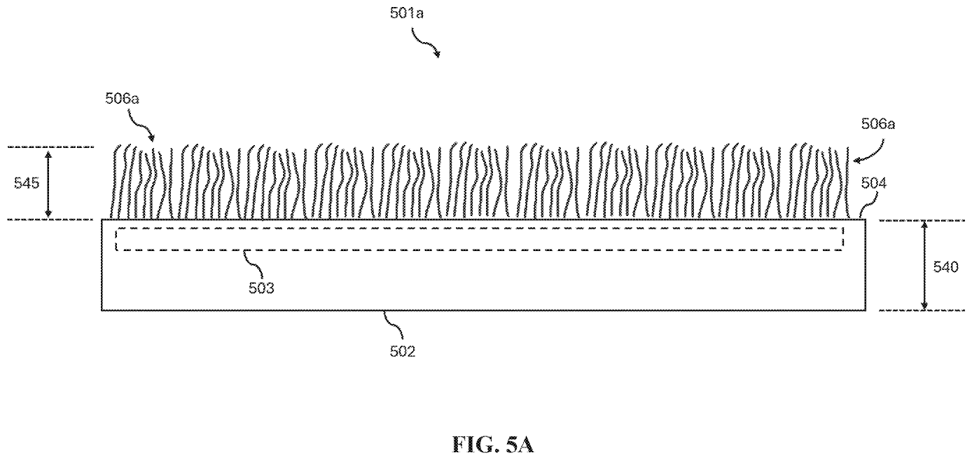

FIG. 4 is diagrammatic side view of a separable fastening device 400, according to some embodiments. The separable fastening device 400 includes a first magnetic strap 401 and a second magnetic strap 411. The first magnetic strap 401 includes a first base 402 having a first coupling surface 404. The first magnetic strap 401 includes a plurality of first elongate members 406 extending from the first coupling surface 404 of the first base 402. The plurality of first elongate members 406 includes a first distal hook 405 having a concave surface 407. Adjacent first elongate members 406 are separated via a first gap 408. The second magnetic strap 411 includes a plurality of second elongate members 416 extending from the second coupling surface 414 of the second base 412. The plurality of second elongate members 416 includes a second hook 415 having a second concave surface 417. Adjacent second elongate members 416 are separated via a second gap 418.

The plurality of first elongate members 406 may include any and/or all features of the plurality of first elongate members 106 described above with respect to FIGS. 1A-E. For instance, the plurality of first elongate members 406 may include a magnetic powder particulate including a ferrous material such as iron, iron alloy, iron boron, steel, a ferritic stainless steel, a magnetic stainless steel, and SAE Steel Grade 400 Series stainless steel distributed throughout the plurality of elongate members via an elastomeric material. The first base 402 and the second base 412 may include a magnet element such as flexible magnetic strips (e.g., neodymium and/or iron boron) and/or a magnetic powder particulate. The first magnetic strap 401 and the second magnetic strap 411 may be magnetically attracted to each other.

In some embodiments, the plurality of second elongate members 416 may not include a magnetic element therein. The plurality of first elongate members 406 may be magnetically attracted to the second base 412, and the second hook 415 may provide a mechanical coupling to retain the plurality of first elongate members 406. Such an arrangement may permit the second magnetic strap 411 to provide mechanical retention with reduced or eliminated magnetic loading in the plurality of second elongate members 416 while maintaining magnetic attraction between the first magnetic strap 401 and the second magnetic strap 411. In other embodiments, the plurality of second elongate members 416 may include a magnetic element therein.

The first distal hook 405 may engage the second hook 415 to retain the first magnetic strap 401 relative to the second magnetic strap 411. The engagement between the first distal hook 405 and the second hook 415 may provide mechanical retention, in addition to the magnetic retention between the first magnetic strap 401 and the second magnetic strap 411. The concave surface 407 of the first distal hook 405 may engage with the second concave surface 417 of the second hook 415. The concave surface 407 may be oriented to face the first coupling surface 404 and the second concave surface 417 may be oriented to face the second coupling surface 414. The position of the first distal hook 405 and/or the second hook 415 may be selected to control a separation distance between the first coupling surface 404 and the second coupling surface 414. In some embodiments, positioning the second hook 415 adjacent to the second coupling surface 414 may provide strong mechanical coupling to keep the first distal hook 405 mechanically and magnetically engaged with the second base 412.

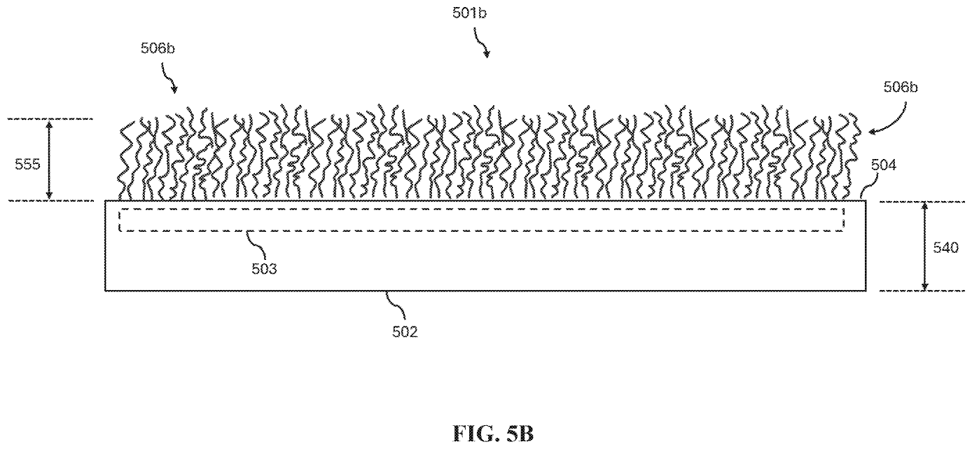

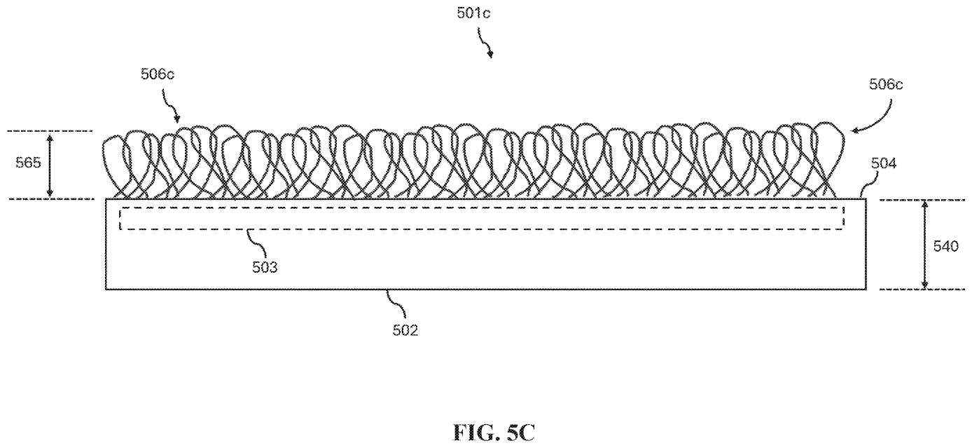

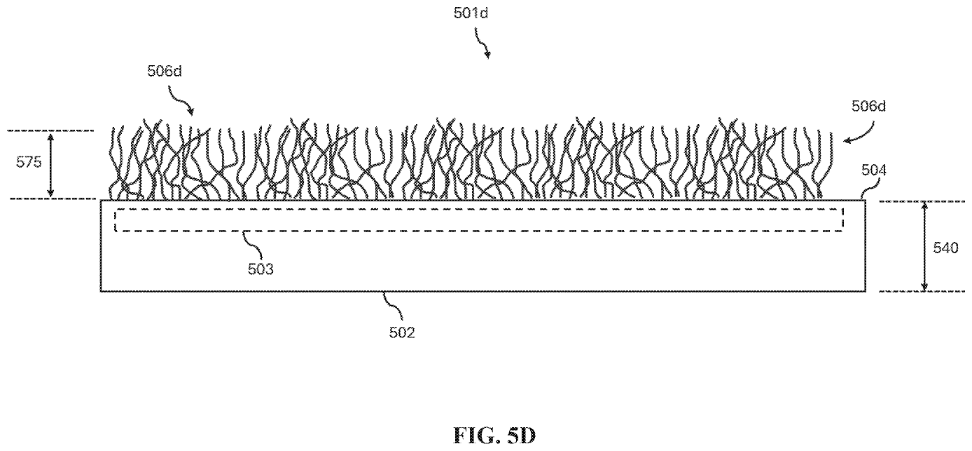

FIG. 5A is a diagrammatic side view of a first magnetic strap 501a of a separable fastening device (e.g., the separable fastening device 100, 200, 300, 400) with a plurality of fibrous members 506a, according to some embodiments. The plurality of fibrous members 506a may include an aspect ratio (length-to-width) of at least 30:1. In other words, the term fibrous refers to an elongate member having a length at least 30 times greater than the width (e.g., when the elongate member height 142 to width 146 ratio is at least 30:1). Each of the plurality of fibrous members 506a may be coupled to a base 502 of the first magnetic strap 501a. A single end (e.g., a proximal end) of each of the plurality of fibrous members 506a may be coupled to a first coupling surface 504 of the first magnetic strap 501a. The base 502 may include a base height 540 and the plurality of fibrous members 506a may extend from the first coupling surface 504 by an extension distance 545. The base height 540 may be greater than, equal to, or less than the extension distance 545. The length of each of the plurality of fibrous members 506a may be greater than the extension distance 545, as in some embodiments, the plurality of fibrous members 506a may include bends, turns, or irregular features such that the total length of the fibrous members 506a is greater than the extension distance 545. The plurality of fibrous members 506a may be oriented substantially parallel with each other. A ratio of the length of each of the plurality of fibrous members 506a to the extension distance 545 may be within a range of 15:10 to 11:10.

The base 502 may include a base magnet 503. Each of the plurality of fibrous members 506a may include a magnetic powder particulate. For instance, each of the plurality of fibrous members 506a may be elastomers, thermosets and/or thermoplastics including the magnetic powder particulate. The magnetic powder particulate may be disposed within each of the plurality of fibrous members 506a. The magnetic powder particulate may coat each of the plurality of fibrous members 506a, for instance, via spraying, dipping, or coating the plurality of fibrous members 506a with the magnetic powder particulate filled elastomer. The fibrous members 506a may also have no magnetic powder particulate so as to provide, in part, a cushioning effect to the magnetic attraction of the base magnet 503.

FIG. 5B is a diagrammatic side view of a first magnetic strap 501b of a separable fastening device (e.g., the separable fastening device 100, 200, 300, 400) with a plurality of fibrous members 506b, according to some embodiments. The plurality of fibrous members 506b may include an aspect ratio (length-to-width) of at least 30:1. Each of the plurality of fibrous members 506b may be coupled to a base 502 of the first magnetic strap 501b. A single end (e.g., a proximal end) of each of the plurality of fibrous members 506b may be coupled to a first coupling surface 504 of the first magnetic strap 501b. The base 502 may include a base height 540 and the plurality of fibrous members 506b may extend from the first coupling surface 504 by an extension distance 555. The base height 540 may be greater, equal to, or less than the extension distance 555. The length of each of the plurality of fibrous members 506b may be greater than the extension distance 555, as in some embodiments, the plurality of fibrous members 506b may include bends, turns, or irregular features such that the total length of the fibrous members 506b is greater than the extension distance 555. A ratio of the length of each of the plurality of fibrous members 506b to the extension distance 555 may be within a range of 25:10 to 12:10.

The base 502 may include a base magnet 503. Each of the plurality of fibrous members 506b may include a magnetic powder particulate. For instance, each of the plurality of fibrous members 506b may be elastomers, thermosets and/or thermoplastics including the magnetic powder particulate. The magnetic powder particulate may be disposed within each of the plurality of fibrous members 506b. The magnetic powder particulate may coat each of the plurality of fibrous members 506b, for instance, via spraying, dipping, or coating the plurality of fibrous members 506b with the magnetic powder particulate filled elastomer. The fibrous members 506b may also have no magnetic powder particulate so as to provide, in part, a cushioning effect to the magnetic attraction of the base magnet 503.

FIG. 5C is a diagrammatic side view of a first magnetic strap 501c of a separable fastening device (e.g., the separable fastening device 100, 200, 300, 400) with a plurality of fibrous members 506c, according to some embodiments. The plurality of fibrous members 506c may include an aspect ratio (length-to-width) of at least 30:1. Each of the plurality of fibrous members 506c may be coupled to a base 502 of the first magnetic strap 501c. Both ends of each of the plurality of fibrous members 506c may be coupled to a first coupling surface 504 of the first magnetic strap 501c (e.g., forming a loop structure). The base 502 may include a base height 540 and the plurality of fibrous members 506c may extend from the first coupling surface 504 by an extension distance 565. The base height 540 may be greater than, equal to, or less than the extension distance 565. The length of each of the plurality of fibrous members 506c may be greater than the extension distance 565, as in some embodiments, the plurality of fibrous members 506c may include bends, turns, or irregular features such that the total length of the fibrous members 506c is greater than the extension distance 565. A ratio of the length of each of the plurality of fibrous members 506c to the extension distance 565 may be within a range of 45:10 to 20:10.

The base 502 may include a base magnet 503. Each of the plurality of fibrous members 506c may include a magnetic powder particulate. For instance, each of the plurality of fibrous members 506c may be elastomers, thermosets and/or thermoplastics including the magnetic powder particulate. The magnetic powder particulate may be disposed within each of the plurality of fibrous members 506c. The magnetic powder particulate may coat each of the plurality of fibrous members 506c, for instance, via spraying, dipping, or coating the plurality of fibrous members 506c with the magnetic powder particulate filled elastomer. The fibrous members 506c may also have no magnetic powder particulate so as to provide, in part, a cushioning effect to the magnetic attraction of the base magnet 503.

FIG. 5D is a diagrammatic side view of a first magnetic strap 501d of a separable fastening device (e.g., the separable fastening device 100, 200, 300, 400) with a plurality of fibrous members 506d, according to some embodiments. The plurality of fibrous members 506d may include an aspect ratio (length-to-width) of at least 30:1. Each of the plurality of fibrous members 506d may be coupled to a base 502 of the first magnetic strap 501d. A single end (e.g., the proximal end) of each of the plurality of fibrous members 506d may be coupled to a first coupling surface 504 of the first magnetic strap 501d. The base 502 may include a base height 540 and the plurality of fibrous members 506d may extend from the first coupling surface 504 by an extension distance 575. The base height 540 may be greater than, equal to, or less than the extension distance 575. The length of each of the plurality of fibrous members 506d may be greater than the extension distance 575, as in some embodiments, the plurality of fibrous members 506d may include bends, turns, or irregular features such that the total length of the fibrous members 506d is greater than the extension distance 575. The plurality of fibrous members 506d may be oriented to intersect each other in an irregular, non-repeating pattern. A ratio of the length of each of the plurality of fibrous members 506d to the extension distance 575 may be within a range of 50:10 to 15:10.

The base 502 may include a base magnet 503. Each of the plurality of fibrous members 506d may include a magnetic powder particulate. For instance, each of the plurality of fibrous members 506d may be elastomers, thermosets and/or thermoplastics including the magnetic powder particulate. The magnetic powder particulate may be disposed within each of the plurality of fibrous members 506d. The magnetic powder particulate may coat each of the plurality of fibrous members 506d, for instance, via spraying, dipping, or coating the plurality of fibrous members 506d with the magnetic powder particulate filled elastomer. The fibrous members 506d may also have no magnetic powder particulate so as to provide, in part, a cushioning effect to the magnetic attraction of the base magnet 503.

The plurality of fibrous members 506a, 506b, 506c, 506d described above may be beneficial for providing a strong magnetic coupling between the magnetic straps 501a, 501b, 501c, 501d and corresponding magnetic straps of opposing polarity. Different arrangements of the plurality of fibrous members 506a, 506b, 506c, 506d may be selected to tune compliance, friction, damping, alignment behavior, and coupling feel for different fastening applications. The high aspect ratio (>50:1) of the fibrous members 506a, 506b, 506c, 506d provide a large surface area for engagement with the opposing magnetic strap, and therefore, provide large friction forces to oppose decoupling. The high aspect ratio (>50:1) of the fibrous members 506a, 506b, 506c, 506d provide a compliant surface (e.g., deformable surface) to dampen sound and mechanical vibrations caused by coupling and decoupling the corresponding magnetic straps.

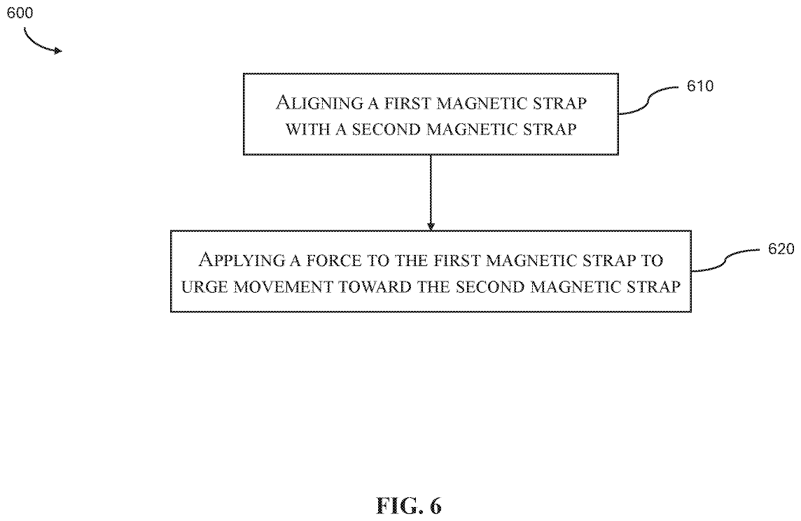

FIG. 6 is a flow chart of a method 600 of releasably fastening components, according to some embodiments. At step 610, the method 600 includes aligning a first magnetic strap with a second magnetic strap. The first magnetic strap and the second magnetic strap may include any and/or all features of the first magnetic strap 101, 201, 301, 401, 501a, 501b, 501c, 501d and the second magnetic strap 111, 211, 311, 411 described above. The first magnetic strap may include a first base magnet and a plurality of first elongate members including a first magnetic powder particulate, and the second magnetic strap may include a second base magnet and a plurality of second elongate members including a second magnetic powder particulate. At step 620, the method 600 includes applying a force to the first magnetic strap to urge movement toward the second magnetic strap. In some embodiments, coupling includes elastomeric deformation and sliding engagement between corresponding elongate members to dampen vibration and reduce sound generated during fastening, and decoupling includes applying a separating, peeling, and/or shearing force to release the first magnetic strap from the second magnetic strap. The plurality of first elongate members are configured to mechanically and magnetically engage the plurality of second elongate members.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fastening device, comprising:
a base including a first coupling surface; and
a plurality of elongate members extending from the first coupling surface of the base, the plurality of elongate members including a magnetic powder particulate and an elastomeric material.

2. The fastening device of claim 1, wherein at least one member of the plurality of elongate members includes a height and a width, wherein an aspect ratio of the height to the width is greater than 2:1.

3. The fastening device of claim 2, wherein adjacent members of the plurality of elongate members are separated by a gap width, wherein the height is greater than the gap width, and wherein the gap width is greater than the width of the at least one member.

4. The fastening device of claim 1, wherein at least one member of the plurality of elongate members extends about a longitudinal axis substantially orthogonal to the first coupling surface.

5. The fastening device of claim 1, wherein the base includes a base magnet.

6. The fastening device of claim 5, wherein the base magnet includes a flexible magnetic strip including neodymium, wherein the flexible magnetic strip includes a thermoplastic coat to provide an elastomeric surface.

7. The fastening device of claim 1, wherein the magnetic powder particulate includes particles having an average size of 0.02 inches or less, wherein a percent by weight of magnetic powder particulate within the plurality of elongate members is within a range of 20% and 95%, and wherein the elastomeric material includes a thermoplastic.

8. The fastening device of claim 1, wherein at least one member of the plurality of elongate members includes a length and a width, wherein an aspect ratio of the length to the width is greater than 30:1.

9. The fastening device of claim 1, wherein the magnetic powder particulate is distributed within the elastomeric material.

10. The fastening device of claim 1, wherein the magnetic powder particulate is coated on the plurality of elongate members via a magnetic powder particulate filled elastomer.

11. The fastening device of claim 1, further comprising:
a second base including a second coupling surface; and
a plurality of second elongate members extending from the second coupling surface of the second base, the plurality of second elongate members including a second magnetic powder particulate,
wherein the second magnetic powder particulate includes an opposite magnetic polarity to the magnetic powder particulate,
wherein the plurality of elongate members are configured to mechanically and magnetically engage the plurality of second elongate members.

12. A fastening device, comprising:
a first base including a magnetic material and a first coupling surface;
a plurality of first elongate members extending from the first coupling surface of the first base, the plurality of first elongate members having an aspect ratio of length to width greater than 10:1; and
a second base including a second coupling surface.

13. The fastening device of claim 12, wherein the second base comprises a plurality of second elongate members having an aspect ratio of length to width greater than 10:1.

14. The fastening device of claim 13, wherein the plurality of first elongate members are configured to mechanically engage the plurality of second elongate members.

15. The fastening device of claim 13, wherein a first gap is positioned between adjacent first elongate members of the plurality of first elongate members and wherein at least one of the plurality of second elongate members is receivable within the first gap, and wherein a second gap is positioned between adjacent second elongate members of the plurality of second elongate members and wherein at least one of the plurality of first elongate members is receivable within the second gap.

16. The fastening device of claim 12, wherein at least one member of the plurality of first elongate members includes a length and a width, wherein an aspect ratio of the length to the width is greater than 30:1.

17. The fastening device of claim 13, wherein the plurality of first elongate members comprise a first magnetic powder particulate.

18. The fastening device of claim 17, wherein the plurality of second elongate members comprise a second magnetic powder particulate.

19. The fastening device of claim 17, wherein the first magnetic powder particulate of the plurality of first elongate members is loaded within an elastomeric material.

20. A method of releasably fastening components, the method comprising:
aligning a first magnetic strap with a second magnetic strap, the first magnetic strap including a plurality of first elongate members including a first magnetic powder particulate and a first elastomeric material, and the second magnetic strap including a plurality of second elongate members including a second magnetic powder particulate and a second elastomeric material; and
applying a force to the first magnetic strap to urge movement toward the second magnetic strap,
wherein the plurality of first elongate members are configured to mechanically and magnetically engage the plurality of second elongate members.
